(19) United States
(12) Patent Application Publication
(10) Pub. No.: US 2013/0053455 A1
(43) Pub. Date: Feb. 28, 2013

(54) INJECTING WATER TO EXTRACT OIL FROM A MATERIAL

(71) Applicants: Robert J. Williams, Willoughby Hills, OH (US); Vincent J. Vavpot, Bay Village, OH (US); Maurice A. Williams, Middleburg Heights, OH (US)

(72) Inventors: Robert J. Williams, Willoughby Hills, OH (US); Vincent J. Vavpot, Bay Village, OH (US); Maurice A. Williams, Middleburg Heights, OH (US)

(73) Assignee: ANDERSON INTERNATIONAL CORP., Stow, OH (US)

(21) Appl. No.: 13/593,939

(22) Filed: Aug. 24, 2012

Related U.S. Application Data
(60) Provisional application No. 61/526,782, filed on Aug. 24, 2011.

(51) Int. Cl. B01D 17/04; B01J 19/00

(52) U.S. Cl. 516/194; 422/111

(57) ABSTRACT

A method for extracting oil from a compressible solid material including oil droplets contained within respective droplet tissues includes injecting liquid water into the compressible solid material; mixing the liquid water into the compressible solid material; if the liquid water is not in a sub-critical condition, bringing the liquid water to the sub-critical condition; and vaporizing the liquid water for releasing energy into the compressible solid material. The released energy ruptures the tissues around at least one of the respective oil droplets for releasing the oil droplets from containment within the respective droplet tissues. The released, oil droplets are extractable by compressing the compressible solid material.

This application claims the benefit of U.S. Provisional Application No. 61/526,782, filed Aug. 24, 2011, which is hereby incorporated by reference.

### BACKGROUND

The present invention relates to removing oil from oil-containing materials. It finds particular application in conjunction with inducing a resonance vibration for removing ail from oil-containing materials and will be described with particular reference thereto. It will be appreciated, however, that the invention is also amenable to other applications.

Extruders and screw presses are currently manufactured for processing, liquid-containing materials like oilseeds and polymers containing water and oil for the separation of non-compressible liquids from compressible solids.

Oil is removed from oil-containing materials using screw presses by attrition into smaller particles by flaking, rolling, sometimes grinding, etc and by bringing the material to desired moisture and temperature levels (e.g., about 2% to about 5% moisture and about 80° C. to about 120° C.). Preparation is done for a number of reasons. One reason is to break down the cellular structure that encapsulates the oil within the tissues of the native oilseed, thus making the liberated oil much easier to press out of the solids in a screw press.

The long standing presumption is that the pressure generated by the screw press forces the non-compressible oil to flow out through slots in the chamber of the press as the compressible solids are compacted into smaller and smaller volume while the solids are forced through the press. Some oil flows through slots early in the press were the solids encounter relatively low compaction, and more oil is released downstream in the press where compaction is greater. At some point, release of oil ceases, for example, when the residual oil level in material is around 5% by weight of the partially de-oiled solid residue. Currently, screw presses seldom produce residual oil level less that around 4% to around 5% and rarely below about 3%. Also, at very low oil levels, heat is generated by friction from the rotating shaft causing the material to become overheated and charred.

The present invention provides a new and improved apparatus and method for exacting oil from a compressible solid material.

### SUMMARY

In one aspect of the present invention, it is contemplated that a method for extracting oil from a compressible solid material including oil droplets contained within respective droplet tissues includes injecting liquid water into the compressible solid material; mixing the liquid water into the compressible solid material; if the liquid water is not in a sub-critical condition, bringing the liquid water to the sub-critical condition; and vaporizing the liquid water for releasing energy into the compressible solid material. The released energy ruptures the tissues around at least one of the respective oil droplets for releasing the oil droplets from containment within the respective droplet tissues. The released oil droplets are extractable by compressing the compressible solid material.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a system for injecting water into a screw press/extruder for extracting oil from a compressible material in accordance with one embodiment of an apparatus illustrating principles of the present invention;

FIG. 2 illustrates a schematic representation of a system for injecting water into a screw press/extruder for extracting oil from a compressible material in accordance with one another of an apparatus illustrating principles of the present invention;

FIG. 3 illustrates a schematic representation of a system for injecting water into a screw press/extruder for extracting oil from a compressible material in accordance with one embodiment of an apparatus illustrating principles of the present invention;

FIG. 4 illustrates a schematic representation of a screw press for extracting oil from a compressible material in accordance with one embodiment of art apparatus illustrating principles of the present invention;

FIG. 5 illustrates a schematic representation of a sound detection device and a bolt in accordance with one embodiment of an apparatus illustrating principles of the present invention; and

FIG. 6 illustrates a schematic representation of a sound detection device attached to a bolt in accordance with one embodiment of an apparatus illustrating principles of the present invention.

### DETAILED DESCRIPTION OF ILLUSTRATED EMBODIMENT

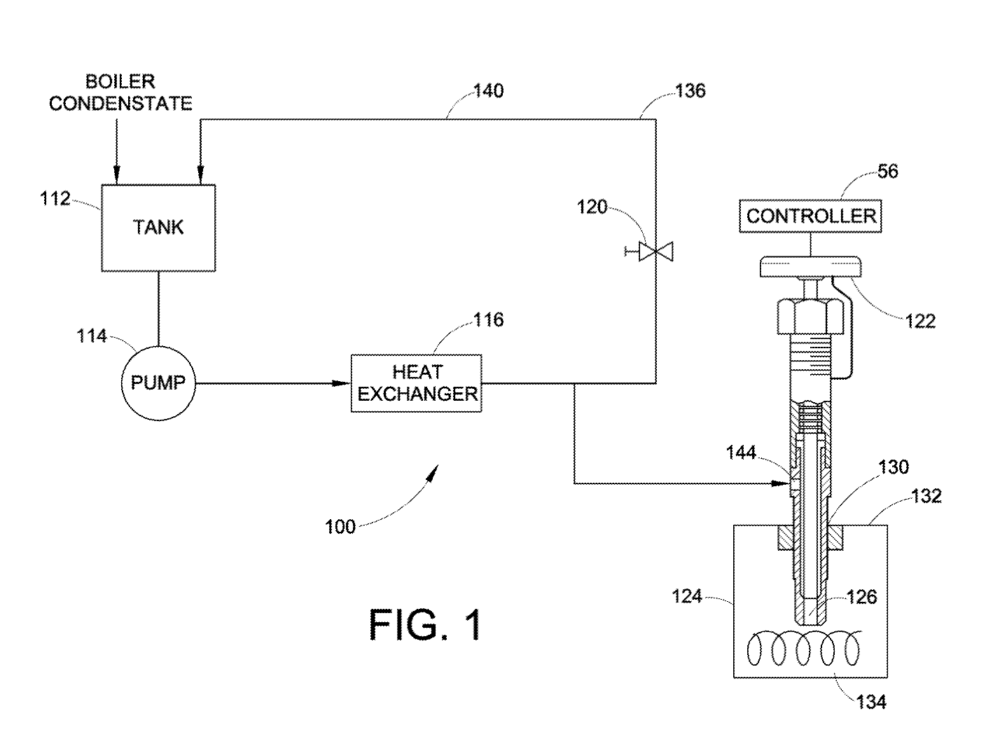

With reference to FIG. 1, a simplified component diagram of an exemplary system 110 for extracting, oil from a solid material is illustrated in accordance with a first embodiment of the present invention. The system 110 includes a tank 112, a pump 114, a heat exchanger 116, a valve 120 for setting pressure (hereinafter referred to as a “pressure valve”), an injection valve 122, and a screw press/extruder 124, etc. for separating (e.g., extracting) non-compressible liquids such as oil from compressible solids. A delivery port 126 of the injection valve 122 is positioned at an injection pun 130 (e.g., a water injection port) along an exterior all 132 of the screw press/extruder 124 to inject a liquid water (e.g., a mixture of water and steam) into a screw press chamber 134 of the screw press/extruder 124. Although only one injection valve 122 is illustrated it is to be understood that additional injection valves for injecting the mixture of water and steam into the screw press/extruder 124 may be positioned at different points along the screw press/extruder 124. As discussed in more detail below, injecting the liquid water into the screw press/extruder 124 at certain positions along the screw press/extruder 124 has been found to be beneficial for separating (e.g., extracting) additional non-compressible liquids such as oil from compressible solids passing through the screw press/extruder 124.

In one embodiment, the tank 112 is a collection tank for boiler condensate that is received into the tank 112 via a port (not illustrated). Tubing 136 creates a circulation loop 140 between the tank 112, the pump 114, the heat exchanger 116, and the pressure valve 120. In the illustrated embodiment, the pressure valve 120 is downstream of the pump 114 and acts as a flow restriction valve for setting a pressure in the circulation loop 140 (e.g., between the heat exchanger 116 and the pressure valve 120). The pressure in the circulation loop 140 between the heat exchanger 116 and the pressure valve 120 is the pressure delivered to the valve 122.

In one embodiment, the tubing 136 is used to recirculate the boiler condensate between the tank 112, the pump 114, the heat exchanger 116, the pressure valve 120, and back to the tank 112. It is contemplated that the pump 114 pumps the boiler condensate at atmospheric pressure out of the tank 112 and recirculates the boiler condensate back to the tank 112 via the circulation loop 140. While passing through the heat exchanger 116, the boiler condensate is brought to a controlled, relatively uniform temperature (e.g., 120° C.) and pressure (e.g., between about 30 atmospheres and about 100 atmospheres) before continuing to be circulated through the circulation loop 140. For example, the condensate is transitioned to liquid (e.g., liquid water) by the heat exchanger 116. In one embodiment, the exchanger 116 heats the condensate to transform the condensate into liquid.

An exit tube 142 is positioned between the heat exchanger 116 and the pressure valve 120—and downstream of the pump 114. A portion of the liquid in the circulation loop 140 is diverted to the exit tube 142 from the circulation loop 140. In other words, a portion attic liquid water is bled-off from the circulation loop 140 to the exit tube 142. Since the exit tube 142 is downstream of the pump 114, the liquid, which is at a relatively higher temperature than the condensate, is either diverted to the exit tube 142 or recirculated through the circulation loop 140. The liquid that is recirculated through the circulation loop 140 (i.e., the liquid water that is not diverted to the exit tube 142) is cooled while passing through the circulation loop 140 before passing through the pump 114 again. Therefore, the hottest liquid does not pass through the pump 114. In this manner, the pump 114 is not used for pumping, the hottest liquid, which is more likely to vaporize, to create pressure in the circulation loop 140.

The relatively hotter and pressurized liquid, which are at the controlled temperature and pressure discussed above, that is diverted to the exit tube 142 is transmitted to the injection valve 122. In one embodiment, the liquid water (e.g., liquid water and steam mixture) is delivered to the injection valve 122 at rates of between about 1 ml per kilogram of material being processed to about 5 ml per kilogram of material being processed. Delivering the liquid and steam mixture to the injection valve 122 at rates higher than about 5 ml per kilogram of material being processed has been found to soften the material being processed in the screw press/extruder 124 to the point that the amount of oil released from the solid is diminished (or even stopped). Delivering the liquid and steam mixture to the injection valve 122 at rates lower than about 1 ml per kilogram of material being processed has been found to not increase the amount of oil released from the solid significantly above the amounts released when no liquid and steam mixture is introduced. The liquid water is transmitted by the exit tube 142 from the circulation loop 140 to an entrance port 144 of the injection valve 122. The injection valve 122 passes the liquid water from the entrance port 144 to the injection valve delivery port 126. The liquid water then passes from the injection valve delivery port 126 to, for example, the screw press chamber 134 of the screw press/extruder 124 via the injection port 130 of the screw press/extruder 124. As discussed in more detail above, injecting the liquid water (e.g., mixture of liquid water and steam) into the screw press/extruder 124 at certain positions along the screw press/extruder 124 has been found to be beneficial for separating (e.g., extracting) additional non-compressible liquids such as oil from compressible solids passing through the screw press/extruder 124.

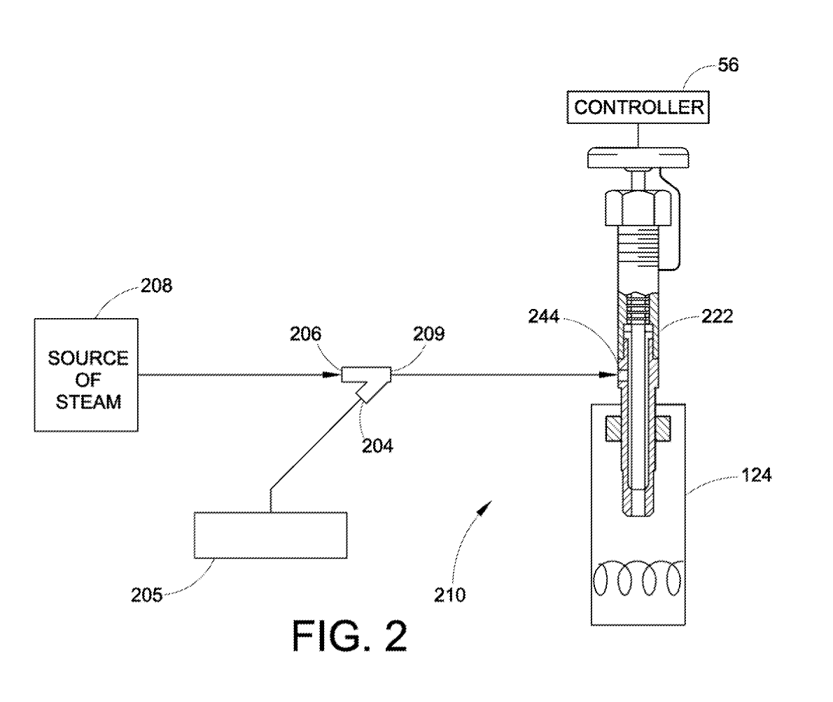

With reference to FIG. 2, a simplified component diagram of an exemplary system 210 for extracting oil from a solid material is illustrated in accordance with a second embodiment of the present invention. For ease of understanding the embodiment of the present invention illustrated in FIG. 2, corresponding components illustrated in FIG. 1 are designated by like numerals increased by one-hundred in FIG. 2. For example, the injection valve 122 of FIG. 1 is referenced as 222 in FIG. 2, while new components are identified with new numerals. In this embodiment, a mixing valve 202 receives a measured stream of steam at a first mixing valve port 204 from a steam source 205 (e.g., a high pressure source of steam). The mixing valve 202 also receives liquid water at a second mixing valve port 206 from a water source 208. In one embodiment, the water source 208 provides measured stream of water at around room temperature (e.g., about 68° F.) at a pressure between about 30 atmospheres and about 100 atmospheres. The water source 208 may be a pump, which optionally includes a flow controller and a flow indicator. However, other structures for the water source 208 are also contemplated. The mixing valve 202 mixes the steam received at the first mixing port valve 204 with the liquid water received at the second mixing port valve 206 to raise the temperature of the liquid water. For example, the measured stream of water bleeds into the steam. The steam both heats and acts to increase the pressure of the liquid water. The resulting liquid water (e.g., liquid water and steam mixture) is delivered from the mixing valve 202 via a mixing valve delivery port 209 to the entrance port 244 of the injection valve 222.

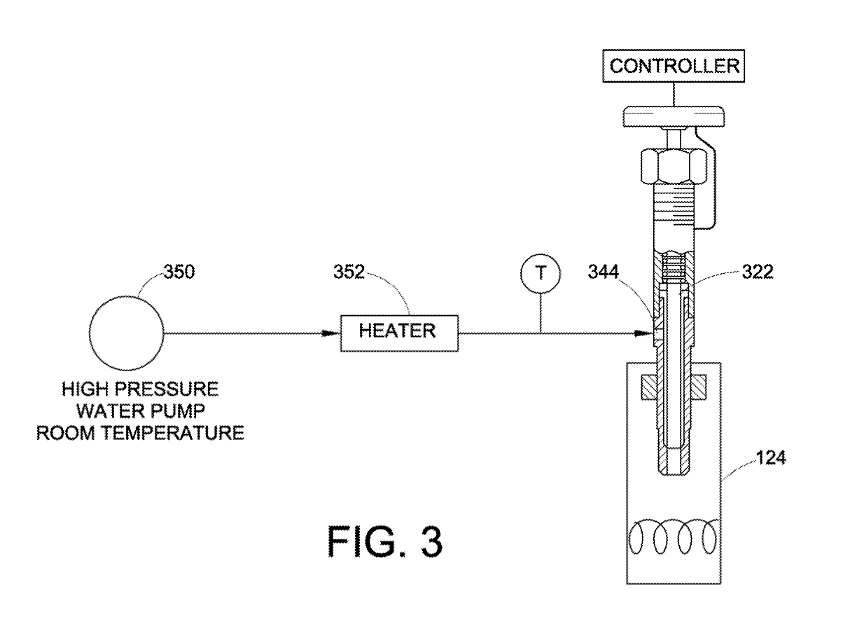

With reference to FIG. 3, a simplified component diagram of an exemplary system 310 for extracting oil from a solid material is illustrated in accordance with a third embodiment of the present invention. For ease of understanding the embodiment of the present invention illustrated in FIG. 3, corresponding components illustrated in FIG. 1 are designated by like numerals increased by two-hundred in FIG. 3, while new components are identified with new numerals. For example, the injection valve 122 of FIG. 1 is referenced as 322 in FIG. 3. In this embodiment, a water pump 350 pumps liquid water at, for example, around room temperature (e.g., between about 68° F.) at a pressure between about 30 atmospheres and about 100 atmospheres through a heater 352. The heater 352 heats the liquid water to the controlled, relatively uniform temperature (e.g., 68° F.) discussed above with reference to FIG. 1. The pressure from the water pump 350 then continues to move the heated water from the heater 352 to the entrance port 344 of the injection valve 322.

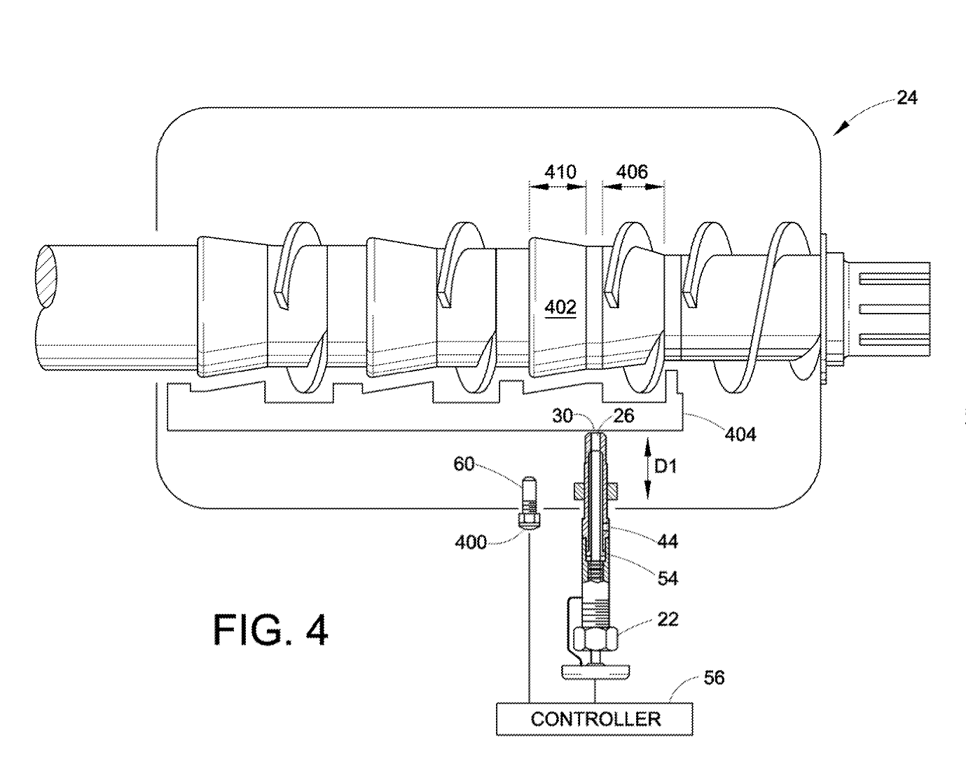

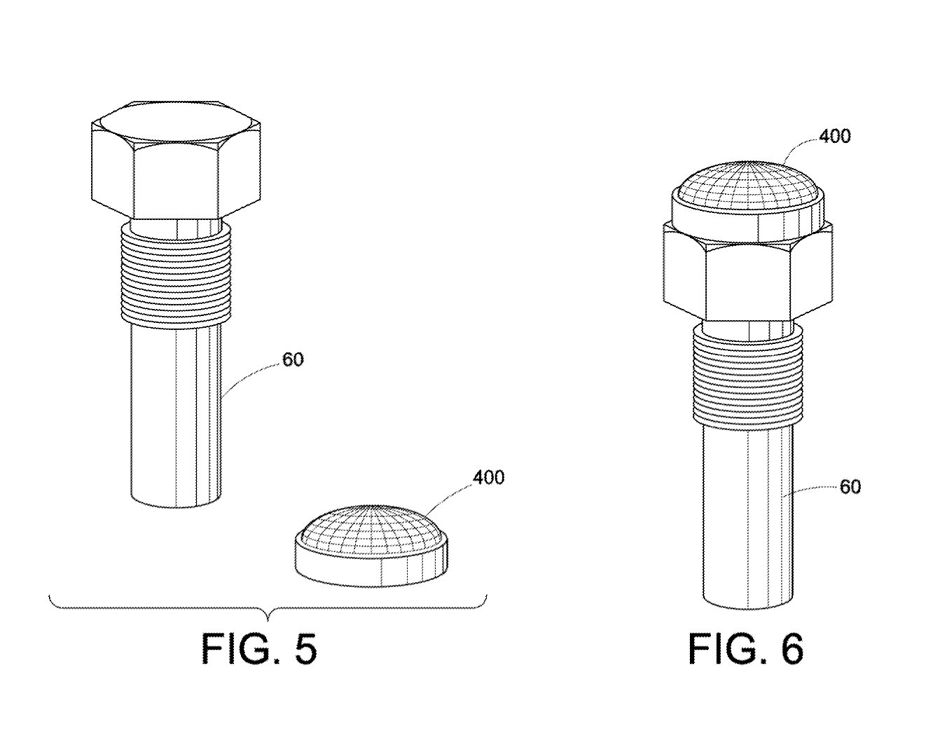

FIG. 4 illustrates an exemplary extruder or screw press 124, 224, 324 (generally referenced as 24) used in FIGS. 1-3. With reference to FIG. 4, at least one sound sensing device 400 (see FIG. 5) is positioned on the extruder or screw press 24 in accordance with one embodiment of the present invention. Steam passing through the injection valves 122, 222, 322 (see FIGS. 13) (generally referenced as 22 in FIG. 4) produce a sound similar to a whistling sound produced when air is blown through a dog whistle. Although the injection valve 22 is illustrated without any source of water connected to the entrance port 44 (which represents the entrance ports 144, 244, 344 of FIGS. 1-3), it is to he understood the entrance port 44 receives water in any of the ways described above with reference to FIGS. 1-3.

A frequency of the sound can be “timed” by adjusting a position of a stem 54 within the injection valve 22 relative to a valve bodies 56. More specifically, the stem 54 may be moved along a longitudinal direction D1 of the injection valve 22 to position the stem 54 for achieving a desired frequency of the sound. The injection valve 22 is positioned along the extruder or screw press so that while the stern 54 moves along, the longitudinal direction D1 of the injection valve 22, the stem 54 moves substantially along a radial direction of the extruder or screw press. However, it is to be understood that other embodiments are also contemplated in which the stem may not move substantially along respective radial directions of the extruder or screw press, the stem still moves along lines that extend into (and out of) the extruder or screw press from the exterior wall 32 around a central longitudinal axis of the extruder or screw press.

The injection valve 22 is a “needle valve” with the liquid water and/or steam entering at the entrance port 44 and exiting at the delivery port 26. The liquid water passes through the valve and enters the screw press water injection port 30 at a pressure based on the position of the stem 54. It is contemplated that the stem 54 is threaded into the valve body 56 and rotated forward (e.g., toward the screw press chamber) and/or backward (away from the screw press chamber) to position the stem 54 relative to the delivery port 26 for controlling the flow of liquid water into the screw press chamber. The rotation of the stem 54 may he accomplished, for example, by a controller 56 (e.g., a servo motor actuator or a pneumatic actuator), or by hand using standard valve handles.

One or more of the sound sensing devices 400 may he positioned along the extruder or screw press 24 downstream of the liquid water injection point(s). In other words, the sound sensing device 400 is positioned downstream of the water injection port 30. In this case, the sound sensing device 400 is mounted on a breaker bolt 60 (see FIG. 6). Similarly, one or more of the sound sensing devices 400 may be positioned along the extruder or screw press 24 on the injection valve 22.

It has been found that the frequency of the sound produced by the liquid water injected into the extruder or screw press 24 (and sensed by the sound sensing device 400) is related to the pressure of the water being injected into the screw press chamber 34. Therefore, to achieve a desired pressure of water being injected into the screw press chamber 34, it is possible to adjust the pressure of the injected water until a predetermined frequency is produced (and sensed by the sound sensing device 400). In other words, it is possible to “tune” the injection valve 22 until a predetermined frequency is produced by the water injected, into the extruder or screw press 24—and sensed by the sound sensing device 400. The tuning may be accomplished by moving the stem 54 along the line that extends into (and out of) the extruder or screw press 24 until the desired frequency is achieved.

It has been found that the amplitude of the sound produced by the water injected into the extruder or screw press 24 (and sensed by the sound sensing device 400) is related to the pressure of the water delivered to the injection valve 22. Therefore, the pressure of the water delivered to the injection valve 22 may by adjusted until a desired amplitude of the sound produced by the water injected by the injection valve 22 (and sensed by the sound sensing device 400) is achieved.

in one example, the sensing device 400 is a Goldwater GT-1005 Wide Dispersion Piezo Tweeter, which comes as an assembly of two pieces: a piezo sensing element and a Horn Driver. The Horn Driver may be removed when the sensing device 400 is mounted directly onto the bolt 60 (e.g., a breaker bolt), which, as discussed above, can be mounted at any position along the screw press or extruder 24.

If the sound sensing, device 400 is mounted on the bolt 60, the sound sensing device 400 detects ultrasonic vibrations from the breaker bolt 60, which picks up the ultrasonic vibrations from the explosive vaporization and collapse of water vapor within the screw press or extruder 24. The signal from the piezo sensing unit can be filtered using a battery operated active high pass filter system to ignore noise below as certain frequency (e.g., below about 7 μHz). Sound at frequencies of about 15 kHz to about 25 kHz has been found to identify noise from the vaporization and collapse of water under sub-critical conditions within screw presses and extruders. It has been found that if the frequency of the sound sensed by the device 400 is within a predetermined range (e.g., about 15 kHz to about 25 kHz), the liquid water in the sub-critical condition in the screw press or extruder 24 acts to desirably increase the amount of oil extracted from the solid material.

During use, the liquid water and/or steam is injected into a compressible solid material including oil droplets in the screw press chamber 34. The water is mixed into the solid material. In one embodiment, the water injected into the compressible solid material including the oil droplets is in the subcritical condition. Alternatively, pressure created in the screw press chamber 34 heats the water to between about 120° C. and 374° C. and pressurizes the water to keep it in the liquid state While between about 120° C. and 374° C. In other words, if the water injected into the screw press chamber 34 is not in the subcritical condition, the water is brought to the subcritical condition by pressure created in the screw press chamber 34.

In the screw press 24 illustrated in FIG. 4, a screw 402 rotates relative to a keeper knife 404. A relatively lower pressure segment 406 is defined where the keeper knife 404 is relatively farther away from the screw 402; whereas a relatively higher pressure segment 410 is defined where the keeper knife 404 is relatively closer to the screw 402. In the illustrated embodiment, the water is injected into the higher pressure segment 410. The pressure created in the material 412 (containing oil droplets in respective droplet tissues) and water being moved by the screw 402 between the keeper knife 404 ensures the water is in the subcritical condition. Therefore, the screw 402 and the keeper knife 404 act as a means for ensuring the liquid is in the subcritical condition. As the screw 402 moves the material 412 and the water to the lower pressure segment 406 in the screw press 24, the water is vaporized (i.e., no longer in the subcritical condition), which releases energy from the water into the material 412. The energy released by the vaporized water ruptures the respective droplet tissues, thereby releasing oil encapsulated by the droplet tissues into the material 412. The screw 402 and the keeper knife 404, along with the higher pressure segment 410, act as a means for vaporizing the liquid water in the subcritical condition. The oil in the material 412 may he extracted by compressing, the material 412 in the screw press 24, as is understood in the art. Therefore, the screw press 24 acts as a means for compressing the compressible solid material including the oil droplets.

As the screw 402 continues to move the water and the material 412 through the press 24, the water and material move from the higher pressure segment 410 to the subsequent lower pressure segment 406. The vapor condenses in the lower pressure segment 406, and the process continues to be repeated as the screw 402 moves the water and the material 412 through the different higher and lower pressure segments 410, 406, respectively, the press 24. The screw 402 and the keeper knife 404, along with the lower pressure segment 406, act as a means for depressurizing and vaporizing the liquid water in the subcritical condition.

The sound sensing device 400 detects sounds created by the water injected from the delivery port 26 of the injection valve 22 into the screw press chamber 34. The sound is transmitted to the controller 56. The controller 56 compares the detected sound with a detected frequency range (e.g., about 15 kHz to about 25 kHz). If the frequency of the detected sound is within the desired frequency range, the controller 56 takes no action. If the sound is not within the desired frequency range, the controller 56 causes the stem 54 of the injection valve 22 to move, which adjusts the pressure of the water injected into the screw press 24 for causing subsequent detected sounds to be within the desired frequency range. It has been found that sounds detected within the desired frequency range result from the liquid water being injected into the screw press chamber 34 at a pressure for extracting desirable amounts of oil from the compressible solid material 412.

Water Injection

The addition of the liquid water in the sub-critical condition discussed above by injection under pressure, so as to keep the water liquid, can increase the amount of oil released from a compressible material, help to compact the oilseed into a hard cake, and prevent charring. The temperature and pressure within a screw press is influenced by the work generated by the motor to elevate temperature through friction and to elevate pressure by compaction. Also a worm/knife bar configuration within the chamber permits some fluctuation of pressure within the chamber. If a screw press or extruder is operated so that a condition is maintained where the non-condensable solids are exposed to fluctuations of pressure and a temperature close to the subcritical temperature for water at that pressure, and heated liquid water under pressure is injected into the chamber of the screw press or extruder, sonic of the liquid water is able to vaporize when pressure drops and to condense back into liquid when the pressure rises. Subcritical conditions occur for water when water is maintained as a liquid by pressure until a pressure is reached where the water is no longer liquid no matter how much the pressure is increased. The upper limit for subcritical conditions occurs when the pressure is around 214 atmospheres and the temperature is around 374° C.

The screw press or extruder 24 is operated to produce numerous pressure changes along the length of the respective chambers where conditions are conducive for water vaporizing and then condensing back into liquid. The pressure changes can be influenced by configuration of the worm shaft and size and position of stationary interruptions along the length of the worm shaft within the pressing chamber. Large releases of energy occurs at those points where some water vaporizes and again when some water vapor re-condenses back into a liquid. These releases of energy greatly help to break down the structure of the solid material, particularly the structure of the envelope surrounding the “oil cells” that contain the oil.

With the breakdown of the oil cell envelope, oil is liberated and is much more easily pressed out of the solids. The injected points for water are into positions along the screw press or extruder. In one embodiment, the water is injected at positions within the closed-wall inlet section before the drainage cage and at injection points emanating from one of the interruptions for the interrupted shaft design. In one example, two to four interruption points are created downstream from the feed hopper. However, the hot pressurized water can be injected at any point along the chamber. At whatever position(s) the hot pressurized water is infected, it is contemplated that the liquid water encounters some points of low pressure where at least a portion of the water can vaporize.

Material coming out of a screw press typically contains about 7% by weight of non-compressible fluids mixed in with the compressible solids. In one example, two non-compressible fluids involved: oil and water. When the level of compressible solids gets high (e.g., around 93%) the solids become so compacted that it is difficult to remove any further amounts of non-compressible liquids. Also low moisture levels are required to insure the desired consistency of the solids within the press (e.g., levels around 2% by weight). So, product leaving the screw press has a total of about 7% residual non-compressible liquid content: about 2 parts water and about 5 parts oil.

Injecting liquid water at some point within the screw press allows liquid water to replace some of the oil absorbed by the material so that the final product exiting the press still has about 7% by weight of non-compressible liquid. However, the injection of water into the material shifts the water to oil ratio. Instead of about 2 parts water and about 5 parts oil, the ratio may be shifted up to about 5 pans water and about 2 pans oil. This shift in the water to oil ratio may result in about 2% residual oil in the pressed material, rather than the customary about 5%. Obtaining about 2% residual oil in the pressed material (as compared to the customary about 5%) is viewed as a substantial improvement in screw press efficiency.

The injection valve itself is a modified interruption device already used for interrupted flight shafts. As discussed above, water injection rates between about 1 ml and about 5 ml per kilogram of material being processed were tested and found to provide acceptable results—adding too much water softens the material and causes a release of oil to stop, and adding, too little water has little or no effect to improve the release of oil. This concept was tested by providing a means of injecting liquid water, under pressure, to points near the interruptions through specially designed injection valves. During the testing, a mist of oil blowing through the drainage cage was observed when the amount of water injection was at optimum levels. If the water injection is stopped, the mist of oil through the cage also stopped: if the water injection was turned back on, the flow of oily mist resumed.

Experimentation was also performed to detect explosive vaporization of water. Such experimentation found that explosive vaporization of water produces a characteristic sound at a range between about 15 kHz to about 25 kHz. The sound can be detected at the point of water injection and also at nearby points. When the sound is detected, indicating that the water is releasing energy in the form of sound waves and other energy forms, one can see improved oil release through the drainage cage. When hot, liquid water under pressure is injected at strategic positions along the worm shaft, at optimum flows, any emitted sound is detected by using sensors picking up the characterics frequency.

Pressurized water may be injected once in a given screw press or extruder or many times to provide for a cross current flow of several flows of injected water crossing the path of the flow of oilseed within the screw press or extruder. The oil-containing material passes through a longitudinal chamber with slotted walls, encountering greater and greater compaction as it moves through the chamber. The hot water enters the chamber through an injector in the side wall and escape through drainage slots downstream of the entry point.

The compressed solids, containing the heated liquid water under pressure, eventually encounter a position along the chamber of lower internal pressure, and some of the water vaporizes. When the compressed solid containing the recently vaporized water vapor encounters a position of increased pressure, the vapor condenses. Every time this phase chance occurs, energy is released into the solids, rupturing the cell structure and releasing the entrained oil.

Another implementation of this method is to combine pressurized water with steam in order to help heat the water and inject the mixture into the screw press or extruder. The heated liquid water can then vaporize as described above.

During testing of pressurized liquid water injection, particularly near the discharge end of the screw press to minimize overheating and charring of the oilseed, some differences in the press cake discharged from the screw press was observed. For example, when liquid water was being injected, the color of the press cake changed—the color could actually be changed by varying the amount of water addition. It was found that color is an indication of how much heat damage is done to the cake.

Also, when injecting liquid water, the surface of the cake facing the grooves of the discharge cone picks up, very visibly, the impressions of the grooves. If liquid water is stopped, the grooves are much less visible, which indicates lower moisture content in the discharging cake. A plume of steam emanating from the cake was visible when liquid water was not injected, indicating that the cake is hotter upon discharge. These observations indicate that injecting pressurized liquid water at strategic points along the barrel does indeed lower press cake temperature and reduces tendency of cake to become scorched.

Steam Injection

The testing method discussed above involved the injection of water in the liquid (non-compressible) state. The method described here involves the injection of water as steam, which is compressible. Steam is routinely injected into extruders to accelerate cooking within the extruder, but small amounts of steam can also be injected into screw press with the liquid water to heat the water. Steam passing through the injection valve emits sound at a range of about 15 kHz to about 25 kHz frequency. Adjusting the stem of the needle valve at different positions relative to a housing of the needle valve to influence the injection of steam “tunes” the valve to a desired frequency. It was observed that the quality of the steam affects the frequency of the sound. Once the valve is tuned in, the stem was left in position relative to the housing of the needle valve. To increase flow of steam (or amplitude of the frequency) the pressure of the applied steam was varied. A flow of steam was injected into the oilseed and at a pressure where it could be determined (by sensing the sound) that the steam is transmitting sound energy into the oilseed. Therefore, the valve may be “tuned” so that the desired frequency is achieved. This is done in addition to adding small amounts of liquid water to feed entering the screw press.

Generating a sound using injected steam transfers energy into the material being treated within the extruder or screw press and causes rupturing of the cell structure and release of the contained oil or other liquid. By “tuning” the injection valves to the desired frequency, the preparation within the extruder or screw press is optimized.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A method for extracting oil from a compressible solid material including oil droplets contained within respective droplet tissues, the method comprising:
injecting liquid water into the compressible solid material;
mixing the liquid water into the compressible solid material;
if the liquid water is not in a sub-critical condition, bringing the liquid water to the sub-critical condition; and
vaporizing, the liquid water for releasing energy into the compressible solid material, the released energy rupturing the tissues around at least one of the respective oil droplets for releasing the oil droplets from containment within the respective droplet tissues, the released oil droplets being extractable by compressing the compressible solid material.

2. The method for extracting oil from a compressible solid material as set forth in claim 1, thither including:
detecting sound caused by the release of energy.

3. The method for extracting oil from a compressible solid material as set forth in claim 2, wherein the detecting step includes:
detecting a frequency of the sound caused by the release of energy.

4. The method for extracting oil from a compressible solid material as set forth in claim 2, further including:
comparing, the detected sound with a desired frequency range; and
if the detected sound is not within the desired frequency range, adjusting a pressure at which the liquid water is injected into the compressible solid material, based on the detected sound, for causing a subsequent detected sound to be within the desired frequency range.

5. The method for extracting, oil from a compressible solid material as set forth in claim 4, further including:
identifying the desired frequency range as between about 15 kHz and about 2.5 kHz.

6. The method for extracting oil from a compressible solid material as set forth in claim 1, wherein the step of bringing the liquid water to the sub-critical condition includes:
increasing a pressure of the liquid water and the compressible solid material.

7. The method for extracting oil from a compressible solid material as set forth in claim 1, further including:
after the vaporizing step, condensing at least a portion of the vaporized water;
vaporizing the condensed water for releasing additional energy into the compressible solid material, the additional released energy rupturing the tissues around at least one additional respective oil droplet for releasing the oil droplets from containment within the respective additional droplet tissues, the additional released oil droplets being, extractable by compressing the compressible solid material.

8. The method for extracting oil from a compressible solid material as set forth in claim 1, wherein the step of vaporizing the liquid water includes:
increasing a pressure of the liquid water.

9. The method for extracting oil from a compressible solid material as set forth in claim 1, further including:
before injecting step, heating the liquid water to the sub-critical condition.

10. The method for extracting oil from a compressible solid material as set forth in claim 1, further including:
injecting steam into the compressible solid material.

11. A system for extracting oil droplets contained within respective oil droplet tissues in a compressible solid material, the system including:
a press, including:
a water injection port receiving liquid water;
means for compressing the compressible solid material, including the oil droplets in the respective oil droplet tissues, and mixing the liquid water into the compressible solid;
means for ensuring the liquid water is in a sub-critical condition;
means for vaporizing the liquid water in the sub-critical condition for releasing energy into the compressible solid material, the released energy rupturing the tissues around at least one of the respective oil droplets for releasing the oil droplets from containment within the respective droplet tissues, the released oil droplets being extracted from the solid material being compressed by the means for compressing; and
a sound sensor for detecting sound released caused by the release of energy; and
a control system controlling the liquid water received into the water injection port, based on the detected sound, for increasing an amount of oil extracted from the solid material.

12. The system for extracting oil from a compressible solid material as set fourth in claim 11, wherein:
the means for ensuring the liquid water is in the sub-critical condition includes a means for pressurizing the liquid water; and
the means for vaporizing the liquid water in the sub-critical condition includes a means for depressurizing the liquid water in the sub-critical condition.

13. The system for extracting oil from a compressible solid material as set fort claim 11, wherein:
the control system compares a frequency of the detected sound with a desired frequency range.

14. The system for extracting oil from a compressible solid material as set forth claim 13, wherein:
the desired frequency range is 15 kHz to 25 kHz.

15. The system for extracting oil from a compressible solid material as set forth in claim 13, wherein:
if the frequency of the detected sound is not within the desired frequency range, the control system causes a pressure of the liquid water received at the water injection port to be adjusted for changing the frequency of the sound caused by the release of energy when the liquid water in the sub-critical condition is vaporized.

16. The system for extracting oil from a compressible solid material as set forth in claim 15, further including:
a water tank:
a pump for pumping water from the tank;
a beater for heating water from the tank; and
a valve for controlling pressure of the liquid water delivered to the water injection port;
wherein the control system controls the valve for adjusting, the pressure of the liquid water received at the water injection port.

17. The system for extracting oil from a compressible solid material as set forth in claim 15, further including:
an injection valve in the water injection port for controlling the liquid water received in the injection port;
wherein the control system controls the injection valve for adjusting the pressure of the liquid water received at the water injection port.
